(19) United States
(12) Patent Application Publication
(10) Pub. No.: US 2026/0069506 A1
(43) Pub. Date: Mar. 12, 2026

(54) PILL OUTFLOW PORT CONTROL NOZZLE

(71) Applicant: The Government of the United States as represented by the Secretary of the Air Force, Wright-Patterson AFB, OH (US)

(72) Inventors: Jess Roach, Whiteman AFB, MO (US); Brandon Ward, Whiteman AFB, MO (US); Blake Gillund, Warrensburg, MO (US); Emily Lucas, Whiteman AFB, MO (US)

(21) Appl. No.: 18/902,876

(22) Filed: Sep. 30, 2024

Related U.S. Application Data
(60) Provisional application No. 63/693,696, filed on Sep. 11, 2024.

(51) Int. Cl. A61J 7/02

(52) U.S. Cl. CPC A61J 7/02

(57) ABSTRACT

A control nozzle assembly includes a port base and a lift gate and is secured to an automated pill counting system having a sloping pill outflow port. The port base includes a body for attachment to the automated counting system and a substantially-vertical and downward facing nozzle supported by the body. The nozzle has a funnel portion with a substantially-vertical passage extending therethrough. An inner side the nozzle facing the body has an opening configured for receiving at least a portion of the pill outflow port therein so that pills exiting the pill outflow port enter the nozzle and are directed downward toward the bottom outlet opening. The lift gate manually moves within a groove in the port base in a vertical direction between a blocking position which prevents the pills from entering the nozzle and a dispensing position which permits the pills to enter the nozzle.

### CROSS-REFERENCE TO RELATED APPLICATIONS

This application claims the benefit of priority under 35 U.S.C. § 119(e) to U.S. Provisional Application Ser. No. 63/693,696 entitled “PILL OUTFLOW PORT CONTROL NOZZLE” filed 11 Sep. 2024. The contents of which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to pharmacy pill counting and/or viewing trays and, more particularly, to a pharmacy pill counting and/or viewing tray that reduces inadvertent spills.

### BACKGROUND OF THE INVENTION

Many pharmacies store pills in large bulk-stock containers. The pills are then counted, packaged into smaller containers, labeled for use, and dispensed to customers as needed. The classic tool for counting pills is a manual pill counting tray. To use a manual pill counting tray, the user first deposits an unknown quantity of pills from a bulk-stock container onto a counting surface or platform of the pill counting tray. A spatula or the like is then used to move pills from this counting surface into an adjoining depressed trough or other dispensing means. The pills moved into the trough are destined to be dispensed. Therefore, the pharmacist is required to remember the changing count of pills reaching the trough throughout the counting process. Once the desired quantity of pills is in the trough, the pharmacist closes a lid over the trough that blocks further pills from being deposited into the trough. By tilting the pill counting tray toward a return funnel or spout, the pharmacist can return uncounted pills, still located on the counting platform, back into the bulk-stock container. By tilting the pill counting tray in a different direction, the counted pills located within the trough are released from the trough through a dispense funnel or spout into a small prescription container such as, for example but not limited to, a vial, a bottle, or the like. At any one pharmacy, this process can be repeated several hundred times during a single day.

These manual pill counting trays have many virtues including durability, low cost, universal applicability to pills of varying shapes and sizes, minimal training requirements, and reputation as a time-honored standard to achieve pill dispensation. In addition, as pills are damaged or different pills are intermixed, it provides an opportunity for the pharmacist to visually assess the pills and remove any damaged pills and/or incorrect type of pills as they are counted.

However, these manual pill counting trays also have drawbacks including accuracy limited to the capability of the pharmacist and concomitant limitations in speed of use. Reliance on human vision and memory as a means of counting is inherently error prone. This inaccuracy can further be explained by distractions that disrupt concentration of the pharmacist while counting. Additionally, the pills can be inadvertently spilled from the pill counting tray, for example but not limited to, when the counting surface is inadvertently tilted too far toward the return funnel or spout, when the trough is inadvertently tilted too far toward the dispense funnel or spout, and/or when the pills are directed into the trough with too much force. It should also be noted that the process itself is fatiguing, thus increasing the likelihood of such user errors.

Many pharmacies have implemented automated or partially automated systems for filling prescriptions to improve drug distribution, control inventory, reduce labor, and decrease medication errors. For example, but not limited to, the Eyecon 9430 pill counting system 10 marketed by Avery Weigh-Tronix USA uses advanced machine vision technology to electronically count pills (best shown in FIG. 1). Images of a counting tray or platter 12 are captured five times per second by an overhead imaging device 14 and electronically analyzed to determine the number of pills currently located on the counting platter 12. Pills can then be added to or removed from the counting platter 12 until a desired number of pills are located and counted on the counting platter 12. Once the desired number of pills are counted on the counting platter 12, the counting platter 12 is tipped up so that the pills slide off of the counting platter 12 and into an inlet or inflow port 16 of a funnel 18 (best seen in FIG. 3). An outlet or outflow port 20 of the funnel 18 is provided that is channel-shaped having an open top side and itself formed as a small funnel. The outflow port 20 angles downward and forward (best shown in FIG. 2).

Flow of the pills from the funnel 18 to the outlet port 20 is controlled by a manually-operated lift gate 22 (not shown in FIG. 1 and best seen in FIG. 2). The lift gate 22 has grooves which receive opposed left and right side edges of a plate 24 mounted above the outlet port 20. The lift gate 22 can be slid up and down along the plate 24 between a blocking position in which the lift gate 22 blocks flow of the pills in the funnel 18 to the funnel outlet port 20 (best seen in FIG. 2) and a flow position which permits flow of the pills in the funnel 18 to the funnel outlet port 20 (best seen in FIG. 3). The lift gate 22 includes a cover portion which covers the open top of the outlet port 20 when the lift gate 22 is in its blocking position.

Despite the benefits, and contrary to expectations, studies have shown that the number of prescription filling errors tends to increase with the implementation of such automated counting systems 10. As a result, automatically filled prescriptions are required to undergo a process known as Full Visual Verification (FVV). This FVV process requires a pharmacist to pour the contents of each automatically filled prescription vial onto a pill counting tray to ensure product consistency. Upon verification that a prescription contains the correct type and number of pills, the pharmacist transfers the contents of the pill counting tray back into the prescription vial. The high volume of prescriptions filled in a typical pharmacy each day often requires the pharmacists to perform the FVV process for many automatically filled prescriptions in sequence. This highly repetitive process of transferring large numbers of pills to and from their respective containers naturally lends itself to errors. One such error, with potentially life-threatening consequences, is commingling of medications due to the inadvertent transfer of stray pill(s) from one prescription vial to another. Structural features of the pill counting tray itself, such as crevices in which pills become temporarily lodged and/or blind spots that limit the pharmacist's ability to identify stray pills, can be a significant factor in these comingling events. In view of the unlimited variety of pill sizes, colors, and shapes (e.g., round, oblong, oval, elliptical, square, cylindrical, rectangular, diamond-shaped, cone-shaped triangular, crescent-shaped, trapezoidal, pentagonal, hexagonal, heptagonal, octagonal etc.) even minor surface disruptions within a pill viewing tray represent potential areas in which a pill may become lodged.

With regard to the above-described automated pill counting systems 10, at least some of the errors are suspected to be related to spillage during the dispensing process. To dispense small pills, the manufacturer recommends lifting and tilting the counting platter 12 to fill the funnel 18 with the pills while the lift gate 22 is in its blocking position. Then gripping a prescription bottle or vial to be filled as shown in FIG. 2 with half of your index finger above the vial and the rest of your hand wrapped around the mouth of the prescription vial. Finally, the funnel gate 18 is raised by raising the hand wrapped around the prescription vial to release the pills down the outlet port 20 and into the prescription vial. The manufacturer notes to never use your other hand to raise the funnel gate 18 in order to avoid spilling the pills. See Eyecon 9430 Quick Reference Guide, the disclosure of which is expressly incorporated herein in its entirety by reference. This warning is made because the hand holding the prescription vial must be used to fill the gap between the prescription vial and the lift gate 22 (which widens as the lift gate 22 rises) or the pills may spill through the gap.

To dispense large pills, the manufacturer recommends gripping the prescription vial or battle as shown in FIG. 3 and then lifting the lift gate 22 completely before lifting and tilting the counting platter 12 to fill the funnel 18 with the pills. With the prescription bottle in position under the lift gate 22, you lift/tilt the counting platter 12 slowly to allow the pills to flow entirely through the funnel 14 and into the prescription bottle without bridging. See Eyecon 9430 Quick Reference Guide, the disclosure of which is expressly incorporated herein in its entirety by reference. Again, your hand must be used to fill the gap between the prescription bottle and the lift gate 22 or the pills may spill through the gap.

Accordingly, an improved pharmacy pill dispensing assembly for an automated pill counting system is needed which is not prone to inadvertently spilling pills when the prescription bottle or vial is not held in required way during a dispensing operation.

### SUMMARY OF THE INVENTION

The present invention overcomes at least some of the foregoing problems and other shortcomings, drawbacks, and challenges of dispensing pill using an automated pill counting system. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a pill outflow port control nozzle assembly for an automated pill counting system includes a port base. The automated pill counting system has a pill outflow port extending downward and outward at an angle. The port base includes a body configured for attachment to the automated pill counting system and a substantially-vertical and downward facing nozzle supported by the body and having a substantially-vertical passage therethrough from a top inlet opening to a bottom outlet opening. An inner side the nozzle facing the body has an opening configured for receiving at least a portion of the pill outflow port therein so that pills exiting the pill outflow port enter the nozzle and are directed substantially-vertical and downward toward the bottom outlet opening.

According to another embodiment of the present invention, a pill outflow port control nozzle assembly for an automated pill counting system having a pill outflow port extending downward and outward at an angle, comprises a port base and a lift gate. The port base includes a body configured for attachment to the automated pill counting system and a substantially-vertical and downward facing nozzle supported by the body and having a substantially-vertical passage extending therethrough from a top inlet opening to a bottom outlet opening. At least a portion of the nozzle is configured as a funnel and an inner side of the nozzle facing the body has an opening configured for receiving at least a portion of the pill outflow port therein so that pills exiting the pill outflow port enter the nozzle and are directed substantially-vertical and downward toward the bottom outlet opening. The lift gate is configured to move manually within a groove in the port base in a vertical direction between a blocking position which prevents the pills from entering the nozzle and a dispensing position which permits the pills to enter the nozzle. A bottom portion of the nozzle is configured to be inserted into an opening of a pill bottle for dispensing the pills into the pill bottle.

According to yet another embodiment of the invention, an automated pill counting system comprises a support structure, a pill viewing tray supported by the support structure, a funnel supported by the structure and adjacent the pill viewing tray for dispensing pills from the pill viewing tray, and a pill outflow port at a lower end of the funnel and extending downward and outward at an angle. A pill outflow port control nozzle assembly comprises a port base including a body secured forward of the pill outflow port and a substantially-vertical and downward facing nozzle supported by the body and having a substantially-vertical passage extending therethrough from a top inlet opening to a bottom outlet opening. An inner side of the nozzle facing the body has an opening configured for receiving at least a portion of the pill outflow port therein so that pills exiting the pill outflow port enter the nozzle and are directed substantially-vertical and downward toward the bottom outlet opening.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of an automated pill counting system of the prior art.

FIG. 2 is a perspective view of small pills being dispensed from the automated pill counting system of FIG. 1 into a prescription bottle or vial.

FIG. 3 is a perspective view of small pills being dispensed from the automated pill counting system of FIG. 1 into a prescription bottle or vial.

FIG. 4 is a perspective view of a pill outflow port control nozzle assembly according to the present invention.

FIG. 5 is a perspective view of the pill outflow port control nozzle assembly of FIG. 4, but wherein a lift gate is fully removed.

FIG. 6 is a perspective view of a port base of the pill outflow port control nozzle assembly of FIGS. 4 and 5.

FIG. 7 is a front elevational view of the port base of FIG. 6.

FIG. 8 is a left-side elevational view of the port base of FIGS. 6 and 7.

FIG. 9 is a cross-section view of the port base taken along line 9-9 of FIG. 7.

FIG. 10 is an enlarged view of a portion of the port base taken along line 10 of FIG. 9.

FIG. 11 is an enlarged view of another portion of the port base taken along line 11 of FIG. 9.

FIG. 12 is top plan view of the port base of FIGS. 6 to 11.

FIG. 13 is a perspective view of the pill outflow port control nozzle assembly of FIGS. 5 and 6.

FIG. 14 is a front elevational view of the lift gate of FIG. 13.

FIG. 15 is a top plan view of the lift gate of FIGS. 13 and 14.

FIG. 16 is a left-side elevational view of the lift gate of FIGS. 13 to 15.

FIG. 17 is a perspective view an automated pill counting system including a pill outflow port control nozzle assembly of FIGS. 5 and 6 according to the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of embodiments of the present invention. Furthermore, these are examples of reduction to practice of the present invention and confirmation that the principles described in the present invention are therefore valid but should not be construed as in any way limiting the scope of the invention.

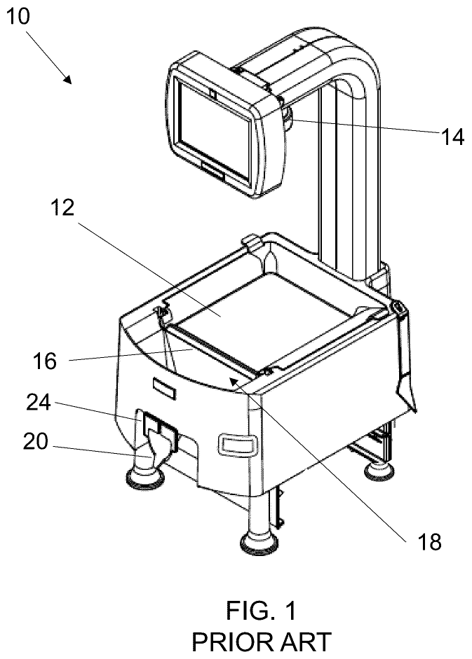

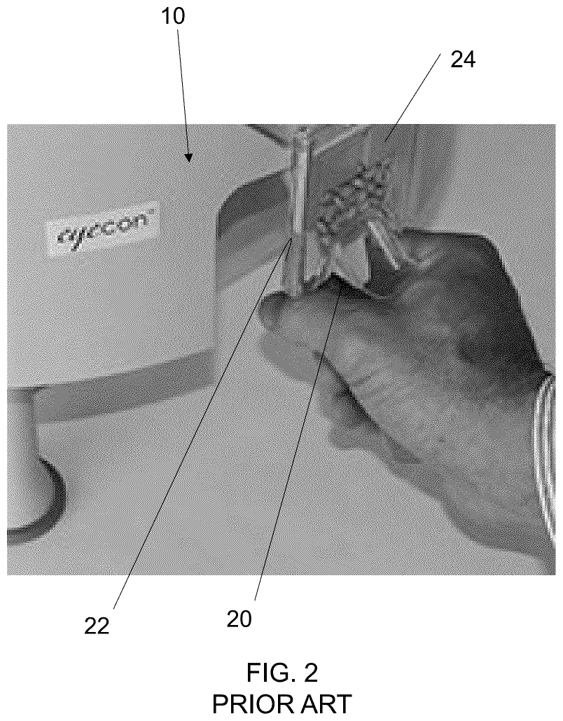

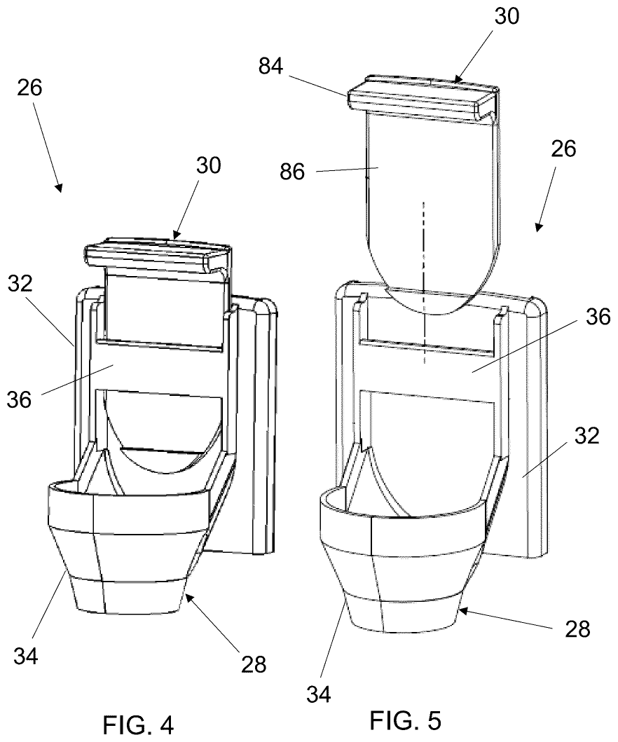

Referring to the drawings, FIGS. 4 and 5 illustrate a pill outflow port control nozzle assembly 26 configured for use on the automated pill counting system 10 having a pill outflow or outlet port 20 extending downward and outward at an angle (best seen in FIGS. 1 and 2). That is, the pill outflow port 20 is sloping downward in the forward direction. The illustrated pill outflow port control nozzle assembly 26 comprises a port base 28 and a lift gate 30 movably secured to the port base 28 as described hereinbelow. It is noted that the pill outflow port control nozzle assembly 26 can alternatively have any other suitable configuration and can alternatively be utilized on any other suitable automated pill counting system.

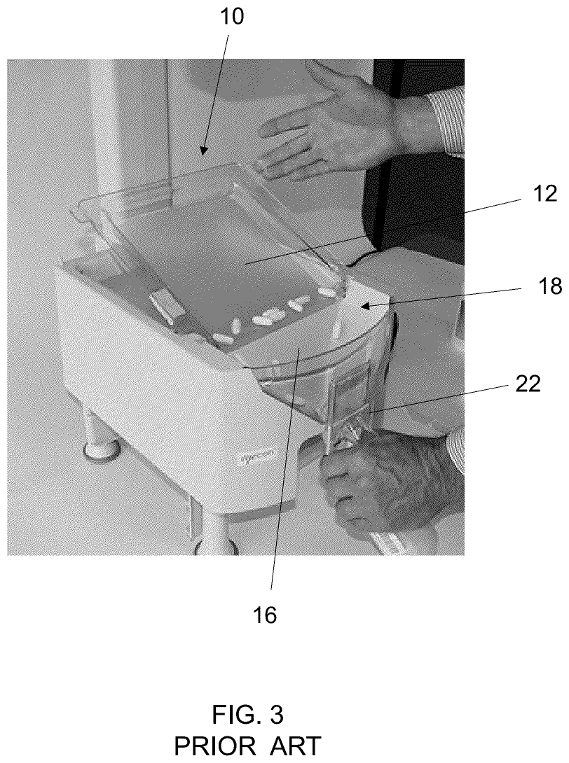

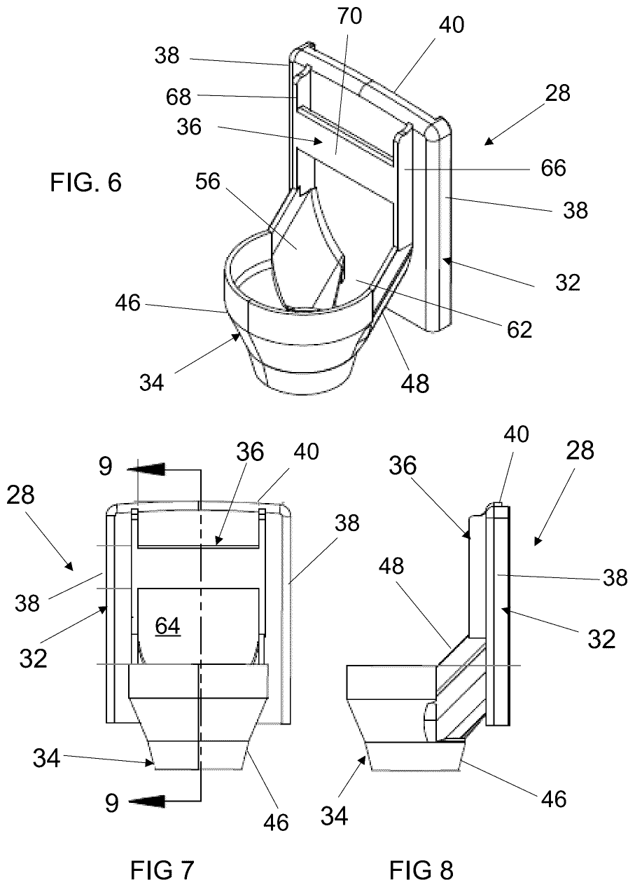

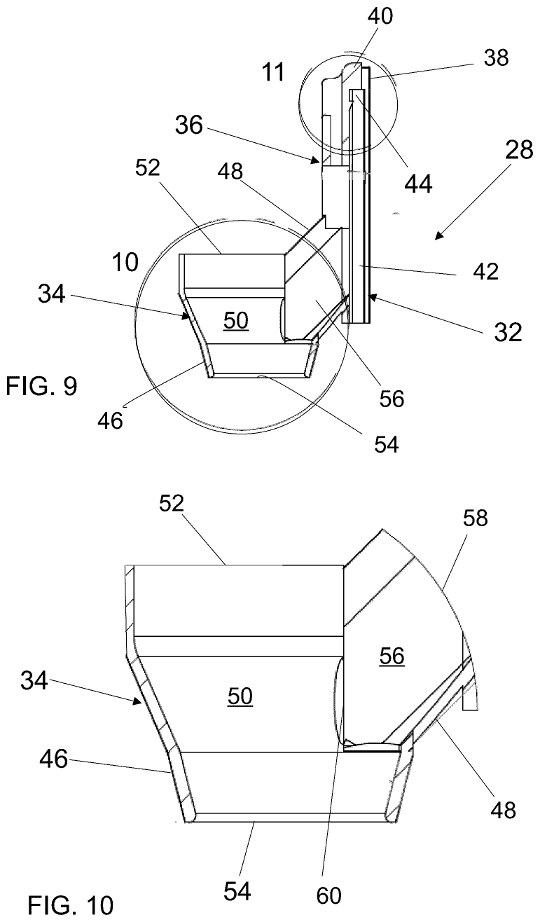

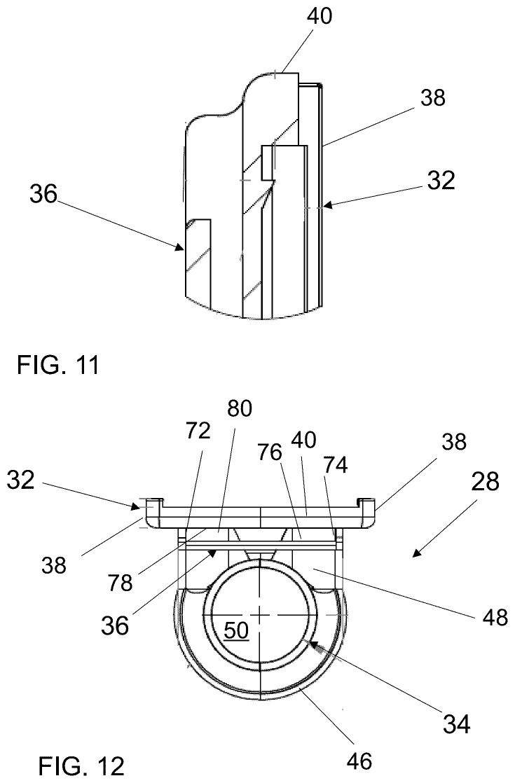

FIGS. 3 to 12 illustrate the port base 28. The illustrated port base 28 includes a body 32 configured for attachment to the automated pill counting system 10 at the outflow port 20, a substantially vertical and downward-facing funnel or nozzle 34 supported by the body 32, and a gate support 36 supported by the body 32 and configured for receiving the lift gate 30 for selective movement between a blocking position blocking flow of pills from the outflow port 20 to the nozzle 34 and a unblocking position permitting flow of pills from the outflow port 20 to the nozzle 34. The illustrated port base 28 is manufactured as a one-piece component but the port base 28 can alternatively have any other suitable configuration.

The illustrated body 32 is generally configured as a rectangular-shaped frame having a pair of vertically extending and laterally spaced apart side members 38, and a horizontally-extending top member 40 connecting upper ends of the side members 38. The lower ends of the side members 38 are connected by the nozzle 34 as described in more detail hereinbelow. The body 32 preferably includes at least one slot or groove 42 configured for receiving a portion of the automated pill counting system 10 to attach the port base 28 to the automated pill counting system 10. The illustrated body 32 has a pair of vertically extending and inward facing slots or grooves 42 configured for receiving the opposed tracks on the left and right edges or tracks of the funnel plate 24 to removably attach the port base 28 to the automated pill counting system 10 at the funnel outlet port 20. It is noted that for the Eyecon 9340, these tracks or edges removably attach the lift gate 22 to the to the automated pill counting system 10 at the funnel outlet port 20 as described hereinabove. It is also noted that the body 32 can alternatively be configured to secured to any other portion or location of the automated pill counting system 10 and/or in any other suitable manner. The illustrated pair of vertically extending and inward facing slots or grooves 42 are formed on the inner lateral sides of the side members 38 so that they are facing each other. The lower end of the grooves 42 are open while the upward ends of the grooves 42 are closed to form downward-facing abutments 44. The abutments 44 enable the body 32 to be supported on the plate 24 when the tracks or edges of the plate 24 are located with the grooves 42. It is noted that the body 32 can alternatively have any other suitable configuration.

The illustrated nozzle 34 includes a first or vertical portion 46 and a second or chute portion 48. The vertical portion 46 has a substantially vertical-extending passage 50 therethrough from a top or inlet opening 52 to a bottom 06 outlet opening 54. The illustrated vertical portion 46 has a circular cross section and is shaped as a funnel in the downward direction. That is, the inlet 52 is larger than the outlet 54. A bottom portion of the illustrated vertical portion 46 is configured to be inserted into an opening of a pill bottle or vial for dispensing the pills into the pill bottle or vial. It is noted that alternatively the bottom portion of the vertical portion 46 can be configured to be receive an opening of a pill bottle or vial therein for dispensing the pills into the pill bottle or vial. It is also noted that the vertical portion 46 can alternatively have any other suitable configuration.

The illustrated chute portion 48 extends downwardly in the forward direction from the body 32 to the vertical portion 46. The illustrated chute portion 48 connects the lower ends of the side members 38 of the body 32. The illustrated chute portion 48 forms a downwardly angled channel 56 from an inlet 58 located at the body 32 to an outlet 60 at the vertical portion 46. An inner side the vertical portion 46 facing the body 32, has an opening formed for the chute portion 48 to merge into the vertical portion 46 so that the vertical passage 50 receives the pills from the channel 56 of the chute portion 48. The illustrated chute portion 48 has a width slightly less than the width of the vertical portion 46 at its top. The chute portion 48 is configured for cooperating with the pill outflow port 20 of the pill counting system 10. The bottom of the illustrated channel 56 of the chute portion 48 has an opening 62 configured for receiving the outlet port 20. This enables the outflow port control nozzle assembly 26 to be slid down onto the plate 24 over the outflow port 20.

Thus, pills exiting the pill outflow port 20 at a downward angle, enter the chute portion 48 and continue at the downward angle until they are directed vertically downward by the vertical passage 50 of the vertical portion 46 toward the outlet opening 54. The downward angle of the chute portion 48 preferably matches the downward angle of the pill outflow port 20. That is, about 45 degrees. It is noted that the pill outflow port 20 also passes through a central opening 62 in the body 32 to the chute portion 48. It is noted that chute portion 48 can alternatively have any other suitable configuration. It is also noted that nozzle 34 can alternatively have any other suitable configuration.

The illustrated gate support 36 includes a pair of laterally spaced-apart and vertically-extending guide members 66, 68, and a horizontally-extending guide member 70. The guide members 66 and 68 extend upward from a rear end of the chute portion 48 and rearward from the body 32 to form a pair of laterally spaced-apart and laterally facing abutments 72, 74 facing each other. The horizontally extending guide member 70 extends laterally between forward sides of the vertically-extending guide members 66, 68 to form a rearward-facing abutment 76. The top member 50 of the body 32 extends laterally between rear sides of the vertically-extending guide members 66, 68 to form a forward-facing abutment 76. The abutments 70, 72, 74, 76, 78 collectively form a vertical passage 80 sized and shaped for slidingly receiving the lift gate 30 therein as described in more detail hereinafter. As best seen in FIG. 12, the illustrated passage is rectangular shaped and located at the forward side of the body 32 and the rear end of the chute portion 48 of the nozzle 34. It is noted that the gate support 36 can alternatively have any other suitable configuration and/or location.

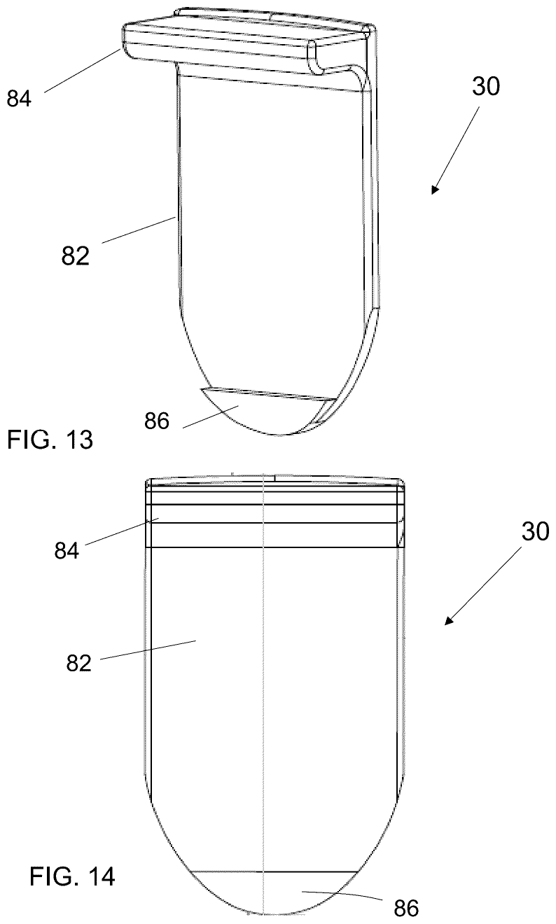

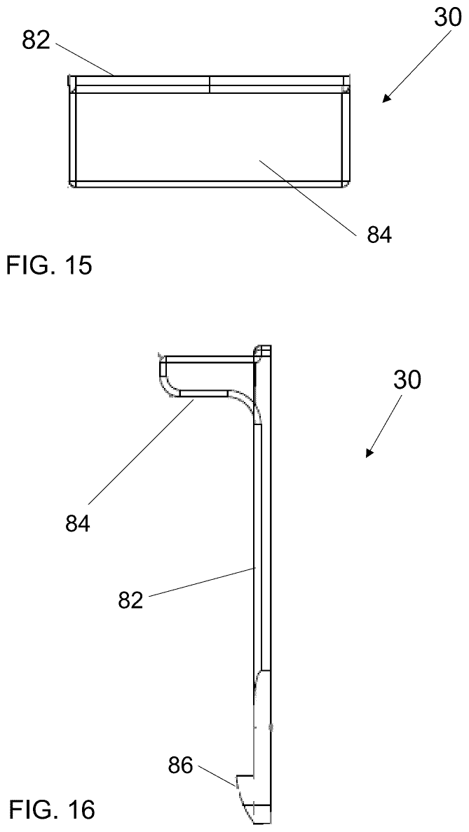

FIGS. 13 to 16 illustrate the lift gate 30. The illustrated lift gate is configured to vertically move between a blocking position which prevents the pills in the outlet port 20 from entering the assembly 26 and a dispensing position which is spaced from the blocking position and permits the pills to exit the pill outflow port 20 into the assembly 26. The illustrated lift gate 30 is manually moved in the vertical direction between the blocking position and the dispensing position by sliding within passage 80 in the port base 28.

The illustrated lift gate 30 has a body portion 82 and a handle portion 84 formed together as a one-piece component. The illustrated body portion 82 is generally thin wall having a width and a thickness sized to be closely received within the passage 80 of the port base 28 for selective vertical sliding motion between the blocking position and the dispensing position. The upper end of the illustrated body portion 82 is substantially straight while the lower end of the illustrated body portion 84 is arcuate or curved. The curved lower end of the body portion is sized and shaped for cooperation with the chute portion 48 of the nozzle 34 and the outflow port 20 of the counting system 10. The illustrated curved lower end is sized and shaped to closely engage the chute portion 48 and the outflow port 20 to prevent the flow of pills when the lift gate is in the blocking position. The illustrated body portion 82 generally has a constant thickness to form substantially flat forward facing and rearward facing surfaces. However, a lowermost portion 86 of the curved lower end has an increased thickness in the forward direction that increases the size of the engagement surface. It is noted that the body portion 82 can alternatively have any other suitable configuration. The illustrated handle portion 84 forwardly extends from the upper end of the body portion 82. The illustrated handle portion 84 is a generally rectangular-shaped block. It is noted that the handle portion 84 can alternatively have any other suitable configuration. It is also noted that the lift gate 30 can alternatively have any other suitable configuration

From the above description it should be appreciated that the illustrated pill outflow port control nozzle assembly 26 can be utilized to upgrade an existing automated pill counting system 10 such as, for example but not limited to the Eyecon 9340, and the like. First the original lift gate 22 is removed from the tracks on the funnel plate 24 by sliding it up and off. Next the port base of the pill outflow port control nozzle assembly 26 is slid down onto the tracks on the funnel plate 24. It is as simple as that. It should also be appreciated that the illustrated pill outflow port control nozzle assembly 26 can alternatively be incorporated into a new automated pill counting system 20.

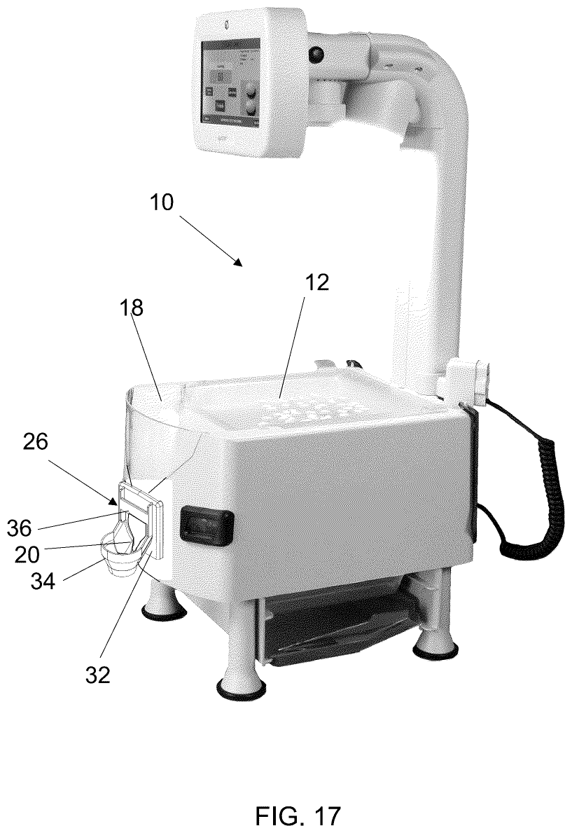

FIG. 17 shows the illustrated pill outflow port control nozzle assembly 26 incorporated on automated pill counting system 20 (with the lift gate 30 removed for clarity). See U.S. Pat. No. 8,682,047 for more details of an exemplary automated pill counting system, the disclosure of which is expressly incorporated herein in its entirety by reference. During use of the on automated pill counting system 20, a user pours a plurality of pills to counted onto the counting tray or platter 12. Images of the counting tray or platter 12 are captured five times per second and analyzed to determine the number of pills on the counting platter 12. Pills are added to or removed from the counting platter 12 until a desired number of pills are counted on the counting platter 12. Once the desired number of pills are counted on the counting platter 12, the counting platter 12 is tipped up so that the pills slide off of the counting platter 12 and into the inlet 16 of the funnel 18. The outlet of the funnel is provided with the channel-shape outflow port 20 having an open top side. The outflow port angles downward and forward (best shown in FIG. 2). Flow of the pills from the outflow port 20 to the nozzle 34 is controlled by the manually-operated lift gate 30. The lift gate 30 is raised and lowered to control the speed and flow of movement out of the funnel 30. The flow of pills exiting the outflow port enter the nozzle at a downward angle and are turned to flow substantially straight downward by the nozzle 34. The change in flow direction optimizes the flow direction for filling a prescription pill bottle or vial. The pills flow downwardly through the nozzle 34 into a pill bottle or vial held at the lower end of the nozzle 34 with the lower end of the nozzle 34 slightly inserted. The nozzle 34 reduces the risk of spilling pills during transfer. This nozzle 34 also eliminates the need for the user to physically contact the pills during transfer, creating a more sanitary environment for pill transfer.

The pill outflow port control nozzle assembly 26 described above is preferably manufactured by 3D printing but can alternatively be manufactured by a variety of forming methods including, for example but not limited to, vacuum forming, injection molding and the like. These forming methods can provide smoothly contoured transitions between the various portions of the pill outflow port control nozzle assembly 26, thereby avoiding edges, crevices, ledges, burrs etc. where pills may become temporarily impeded and/or lodged.

Plastics known in the art may be used to provide the pill outflow port control nozzle assembly capable of withstanding repetitive use as well as high impact forces, such as when inadvertently dropped to the floor. For example, but not limited to, high-density polyethylene (HDPE), low density polyethylene (LDPE), polypropylene (PP) and the like. Due to the wide variety pill colors and compositions, the polymers used to form the components preferably include a color that provides a high contrast.

The pill outflow port control nozzle assembly 26 described above may comprise a variety of sizes and shapes and is in no way limited to the shapes, dimensions, and/or proportions shown in the present figures.

As used in this specification and the claims, the term “spout” means any object having a passage through which liquid or solid contents of a container may be passed or poured. As used in this specification and claims, the term “funnel” means any object forming a passage that is wider at an entrance and narrower at exit, used for guiding liquids or solids into a smaller opening.

The phrase “and/or,” as used in this specification should be understood to mean “either or both” of the elements being referred to, i.e., elements that are conjunctively present in some instances and disjunctively present in other instances. Other elements may optionally be present other than the elements specifically identified by the “and/or” clause, whether related or unrelated to those elements specifically identified unless clearly indicated to the contrary.

As used in this specification, the term “preferably” refers to one or more exemplary embodiments of the invention and therefore is not to be interpreted in any limiting sense.

The terms “comprises,” “comprising,” “includes,” “including,” “has,” “having,” or any other variations thereof used herein, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference to “one embodiment,” “certain embodiments,” “an embodiment,” “implementation(s),” “aspect(s),” or similar terms used herein means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

It will be understood that terms of orientation and/or position as may be used throughout the specification and claims, such as upper, lower, rear, side, forward, downward, upward, inner, and so on, as well as their derivatives and equivalent terms, relate to relative rather than absolute orientations and/or positions.

All patents, patent applications (and any patents which issue thereon, as well as any corresponding published foreign patent applications), publications, and other documents mentioned throughout this description are hereby incorporated by reference herein. It is expressly not admitted, however, that any of the documents incorporated by reference herein teach or disclose the present invention.

The words “about,” “approximately,” or the like, when accompanying a numerical value, are to be construed as indicating a deviation as would be appreciated by one of ordinary skill in the art to operate satisfactorily for an intended purpose.

It should be understood that every maximum numerical limitation used herein includes every lower numerical limitation, as if such lower numerical limitations were expressly written herein. Every minimum numerical limitation used herein includes every higher numerical limitation, as if such higher numerical limitations were expressly written herein. Every numerical range herein includes every narrower numerical range that falls within such broader numerical range, as if such narrower numerical ranges were all expressly written herein.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

References herein to items in the singular should be understood to include items in the plural, and vice versa, unless explicitly stated otherwise or clear from the text.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A pill outflow port control nozzle assembly for an automated pill counting system having a pill outflow port extending downward and outward at an angle, said pill outflow port control nozzle assembly comprising:
a port base including a body configured for attachment to the automated pill counting system and a substantially-vertical and downward facing nozzle supported by the body and having a substantially-vertical and downward extending passage therethrough from a top inlet opening to a bottom outlet opening; and
wherein an inner side the nozzle facing the body has an opening configured for receiving at least a portion of the pill outflow port therein so that pills exiting the pill outflow port enter the nozzle and are directed substantially vertically downward toward the bottom outlet opening.

2. The pill outflow port control nozzle assembly according to claim 1, further comprising a lift gate configured to move between a blocking position which prevents the pills from entering the nozzle and a dispensing position which permits the pills to enter the nozzle.

3. The pill outflow port control nozzle assembly according to claim 2, wherein the lift gate manually moves between the blocking position and the dispensing position.

4. The pill outflow port control nozzle assembly according to claim 2, wherein the lift gate moves in the vertical direction between blocking position and the dispensing position.

5. The pill outflow port control nozzle assembly according to claim 2, wherein the transfer gate closely slides within a passage of the port base.

6. The pill outflow port control nozzle assembly according to claim 2, wherein the port base has at least one slot configured for receiving a portion of the automated pill counting system to attach the port base to the automated pill counting system.

7. The pill outflow port control nozzle assembly according to claim 1, wherein at least a portion of the nozzle is configured as a funnel.

8. The pill outflow port control nozzle assembly according to claim 1, wherein a bottom portion of the nozzle is configured to be inserted into an opening of a pill bottle for dispensing the pills into the pill bottle.

9. A pill outflow port control nozzle assembly for an automated pill counting system having a pill outflow port extending downward and outward at an angle, said pill outflow port control nozzle assembly comprising:
a port base including a body configured for attachment to the automated pill counting system;
a substantially-vertical and downward facing nozzle supported by the body and having a substantially-vertical passage extending therethrough from a top inlet opening to a bottom outlet opening;
wherein at least a portion of the nozzle is configured as a funnel;
wherein an inner side of the nozzle facing the body has an opening configured for receiving at least a portion of the pill outflow port therein so that pills exiting the pill outflow port enter the nozzle and are directed substantially vertically downward toward the bottom outlet opening;
a lift gate configured to manually move within a passage in the port base in a substantially-vertical direction between a blocking position which prevents the pills from entering the nozzle and a dispensing position which permits the pills to enter the nozzle; and
wherein a bottom portion of the nozzle is configured to be inserted into an opening of a pill bottle for dispensing the pills into the pill bottle.

10. An automated pill counting, inventory, and validation system comprising:
a support structure;
a pill viewing tray supported by the support structure;
a funnel supported by the support structure and located adjacent the pill viewing tray for dispensing pills from the pill viewing tray;
a pill outflow port at a lower end of the funnel and extending downward and outward at an angle;
a pill outflow port control nozzle assembly comprising a port base including a body secured forward of the pill outflow port and a substantially-vertical and downward facing nozzle supported by the body and having a substantially-vertical passage therethrough from a top inlet opening to a bottom outlet opening; and
wherein an inner side of the nozzle facing the body has an opening configured for receiving at least a portion of the pill outflow port therein so that pills exiting the pill outflow port enter the nozzle and are directed substantially-vertically downward toward the bottom outlet opening.

11. The automated pill counting system according to claim 10, the pill outflow port control nozzle assembly further comprising a lift gate configured to move between a blocking position which prevents the pills from entering the nozzle and a dispensing position which permits the pills to enter the nozzle.

12. The automated pill counting system according to claim 11, wherein the lift gate manually moves between blocking position and the dispensing position.

13. The automated pill counting system according to claim 11, wherein the lift gate moves in the vertical direction between the blocking position and the dispensing position.

14. The automated pill counting system according to claim 11, wherein the transfer gate slides within a substantially-vertical passage in the port base.

15. The automated pill counting system according to claim 11, wherein the port base has slots configured for receiving tracks on left and right edges of a plate to attach the port base.

16. The automated pill counting system according to claim 10, wherein at least a portion of the nozzle is configured as a funnel.

17. The automated pill counting system according to claim 10, wherein a bottom portion of the nozzle is configured to be inserted into an opening of a pill bottle for dispensing the pills from the nozzle to the pill bottle.
